(19) United States
(12) Patent Application Publication
(10) Pub. No.: US 2007/0300019 A1
(43) Pub. Date: Dec. 27, 2007

(54) Memory access apparatus, memory access method and memory manufacturing method

(75) Inventors: Yoshinori Hiraike, Kawasaki (JP); Katsuaki Yamanaka, Kawasaki (JP); Hirokazu Shimada, Kawasaki (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/591,589

(22) Filed: Nov. 2, 2006

(30) Foreign Application Priority Data
Jun. 27, 2006 (JP) 2006-177267

(51) Int. Cl. G06F 13/00

(52) U.S. Cl. 711/154

(57) ABSTRACT

A memory access apparatus for carrying out access to memories for which types of access control signals required for accessing are different from each other, has an access control signal type information obtaining part configured to obtain information of a type of the access control signal for the memory to access.

### BACKGROUND OF THE INVENTION

1. Field of the Invention

The present invention relates to a memory access apparatus, a memory access method and a memory manufacturing method.

2. Description of the Related Art

When carrying out communication with an external device such as a memory from an information processing apparatus, it is necessary to use a signal of a type suitable to the device to access.

Japanese Laid-open Patent Application No. 7-104943 discloses an art of interface for an external device.

In this art, an information transmission apparatus is provided with an external device, an information recording medium and a driver for accessing the information recording medium, information transmission is carried out between the external device and the information recording medium via the driver, an information recording medium side interface has a form corresponding to the type of the information recording medium, an external device side interface has a form corresponding to a standard type, and a type converting part is provided for appropriately converting a signal transmission type between the information recording medium side interface and the external device side interface.

In this case, the type converting part may convert the transmission type according to predetermined conversion contents.

Japanese Laid-open Patent Application No. 8-56246 discloses an art in which, when an IC card radio modem is connected, an information terminal apparatus reads attribute information of respective communication interface circuits included in a CIS circuit of an interface part, sends an index number indicating a communication interface circuit corresponding to its own interface to a PCMCIA interface circuit and writes the same there. Then, a control part outputs a selection signal to a switch circuit, to connect between the communication interface circuit corresponding to the information terminal apparatus and a radio modem part.

In this art, an appropriate one of the plurality of communication circuits previously prepared is selected, and therewith, connection with the radio modem part is achieved.

Japanese Laid-open Utility-Model Application No. 6-51929 discloses a configuration in which, a timing generating part generates a latch timing signal when an address of digital data from a computer reaches a predetermined value, and a latch circuit holds digital data according to the latch timing signal and outputs the same to a DAC selection circuit. The digital data includes an operation condition of a control part. The DAC selection circuit selects an operation condition of the control part according to the digital data and an operation condition input from the computer sequentially, and outputs the same to the control part. The control part is thus set in the predetermined operation condition, and operates accordingly.

In this art, when the computer is connected to a peripheral, operation condition of the control part, when the peripheral is automatically recognized as a result of the address from the computer being used for comparison, is determined under the control by the computer.

### SUMMARY OF THE INVENTION

In these prior arts, an interface condition required for communication with an external device is obtained based on information previously prepared.

On the other hand, for a case where information concerning such an interface condition required for communication with an external device is not previously prepared, it is necessary to actually study the type of the external device in detail, and then, to design the interface condition manually.

The present invention has been devised in consideration of this situation, and an object of the present invention is to provide a simple configuration by which necessary interface condition required for communication with an external apparatus can be easily and positively obtained and set.

According to one aspect of the present invention, information of a type of an access control signal suitable to a memory as an external device is previously stored in the memory itself. Then, when accessing the memory, the information thus stored is read, and, according thereto, the access control signal suitable to the memory is generated.

By configuring so, it is possible to easily and positively generate the access control signal of the type suitable to the memory, when accessing the memory as the external device.

### BRIEF DESCRIPTION OF THE DRAWINGS

Other objects and further features of the present invention will become more apparent from the following detailed description when read in conjunction with the accompanying drawings:

FIG. 1 shows an apparatus configuration in one embodiment of the present invention;

FIG. 2 shows a work flow chart for illustrating a memory manufacturing method in one embodiment of the present invention;

FIG. 3 shows an operation flow chart for illustrating a memory access method in one embodiment of the present invention;

FIGS. 4 and 5 show a timing chart and corresponding table data of access request signals for a single write access in the memory access method according to the embodiment of the present invention;

FIGS. 6 and 7 show a timing chart and corresponding table data of access request signals for a burst write access in the memory access method according to the embodiment of the present invention;

FIGS. 8 and 9 show a timing chart and corresponding table data of access request signals for a signal read access in the memory access method according to the embodiment of the present invention;

FIGS. 10 and 11 show a timing chart and corresponding table data of access request signals for a burst read access in the memory access method according to the embodiment of the present invention;

FIG. 12 shows a timing chart of access control signals for a single write access to a slave side device (memory) in the memory access method in the embodiment of the present invention;

FIG. 13 shows table data of the access control signals for a single write access to a slave side device (memory) in the memory access method in the embodiment of the present invention;

FIG. 14 shows a timing chart of access control signals for a read access to a slave side device (memory) in the memory access method in the embodiment of the present invention;

FIG. 15 shows table data of the access control signals for a read access to a slave side device (memory) in the memory access method in the embodiment of the present invention;

FIG. 16 illustrates definitions of memory type information in the embodiment of the present invention;

FIG. 17 illustrates table data stored in the slave side device (memory) in the embodiment of the present invention;

FIG. 18 shows a block diagram showing, in detail, a configuration including an interface part in the apparatus configuration shown in FIG. 1;

FIG. 19 shows table data illustrating an access control signal generating method in the memory access method according to the embodiment of the present invention;

FIG. 20 shows a timing chart for illustrating the access control signal generating method in the memory access method according to the embodiment of the present invention;

FIG. 21 illustrates a table data storage manner used for accessing a flash memory in the embodiment of the present invention;

FIG. 22 illustrates table data illustrating an access control signal generating method for the flash memory in the memory access method according to the embodiment of the present invention;

FIGS. 23 and 24 show timing charts for illustrating the access control signal generating method for the flash memory in the memory access method according to the embodiment of the present invention;

FIG. 25 shows a timing chart (between the memory access apparatus 10 and the CPU 50) of an example of access request signals for accessing an SDRAM in the embodiment of the present invention;

FIG. 26 shows a timing chart (between the memory access apparatus 10 and the CPU 50) of an example of access control signals for the SDRAM in the embodiment of the present invention; and

FIG. 27 shows a block diagram illustrating an example of a hardware configuration of the memory access apparatus 10 shown in FIG. 1.

### DETAILED DESCRIPTION OF THE PREFERRED EMBODIMENTS

Embodiments of the present invention will now be described in detail with reference to figures.

In an embodiment of the present invention, when setting conditions required for accessing a memory as an external device, definition information for each single signal line is read out from the memory itself, and the setting is carried out based on the thus-read-out information. Accordingly, any design work for achieving the setting becomes unnecessary. According to this method, not only for existing devices, but also for those which will be created through a development, the same manner can be applied, in a flexible manner.

Such a configuration is advantageous particularly for a case where, manufacture of a device as a part currently used is finished, and therefor, another device which is newly developed is used to replace. That is, according to the embodiment of the present invention, different from a way in which, information is selected from those corresponding to existing limited devices, necessary information is obtained from the device itself. Accordingly, even when replacement is made with the device for which details are unknown, it can be properly handled positively.

According to the embodiment of the present invention, in an integrated circuit such as an LSI circuit, a FPGA circuit, a processor, or such, for a communication apparatus, an information processing apparatus, or such, information concerning access timing suitable to an external memory device which is employed as a peripheral is automatically collected, and corresponding access control signals are automatically generated based thereon. Thereby, problems which may occur for an access interface for a device can be easily and positively solved.

A specific example of the access interface for a device is access timing suitable to the device.

In the related art, when accessing a memory, design of access timing for the memory is required. Each time when changing the memory to employ, design should be made again, and thus, costs required for the development increases accordingly.

Further, since the design is made by a designer manually in the related art, human error such as design error may occur.

Further, when a situation that manufacture of a part mounted in an apparatus is finished occurs, it is necessary to replace it with a product of another manufacturer, and thus, design of access timing should be made again therefor.

According to the embodiment of the present invention, information concerning access timing is previously stored in each device product itself as mentioned above, and thus, these problems can be easily and positively solved.

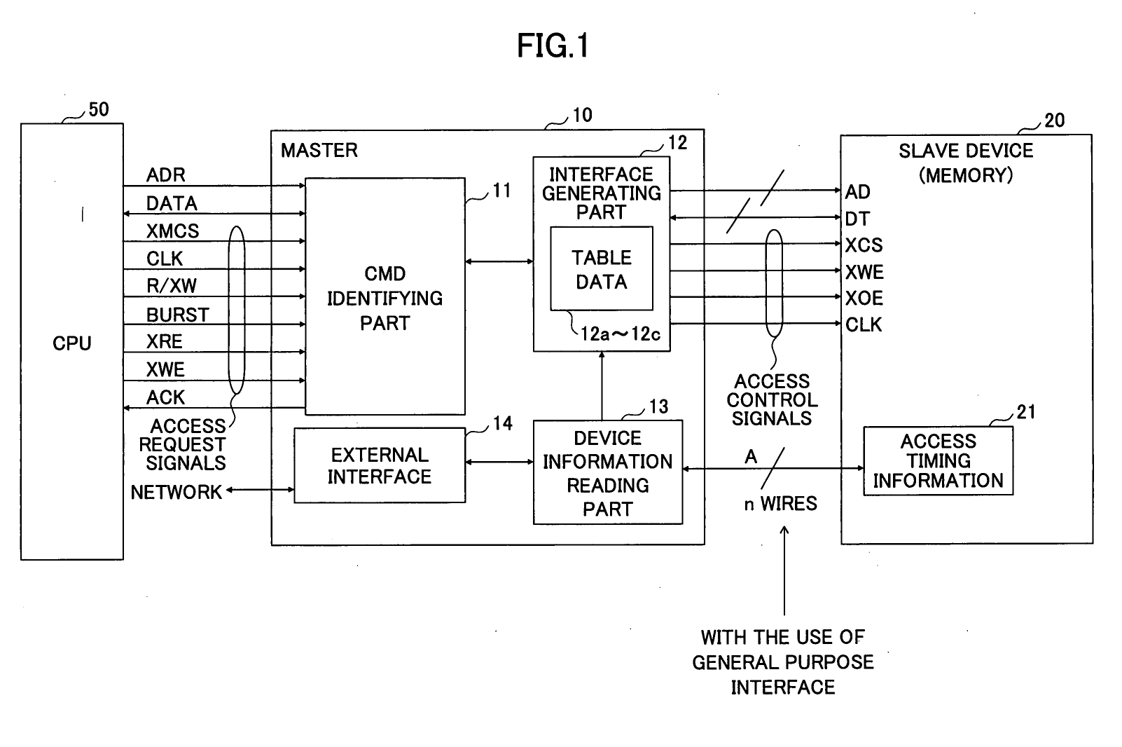

FIG. 1 shows a block diagram of an information processing apparatus including a memory access apparatus 10 in the embodiment of the present invention.

This information processing apparatus includes a CPU 50 for controlling the entirety of the apparatus, a memory 20 as an external apparatus, and the memory access apparatus 10 for enabling access to the memory 20 from the CPU 50.

This memory access apparatus 10 may be configured by an integrated circuit such an FPGA circuit, an LSI circuit, or such.

Here, the memory access apparatus 10 acts as a master, while the memory 20 as an external device to access from the CPU 50 acts as a slave.

To the slave side, a plurality of memories 20 or devices of different types, may be connected.

As shown in FIG. 1, the memory access apparatus 10 includes a CMD identifying part 11, an interface generating part 12, device information reading part 13 and an external interface 14.

The device information reading part 13 automatically accesses the device on the slave side, i.e., the memory 20, via a general purpose interface, at a time of starting up of (or reset of) the information processing apparatus shows in FIG. 1 including the memory access apparatus 10, and reads access timing information 21 from the memory 20.

The interface generating part 12 automatically generates access control signals concerning input/output timing for the memory 20, based on the information thus read out by means of the device information reading part 13.

The CMD identifying part 11 receives access request signals from the interface generating part 12 and the CPU 50, to determine whether the corresponding access request from the CPU 50 is for a read access or a write access.

The external interface 15 acts as an interface for accessing externally.

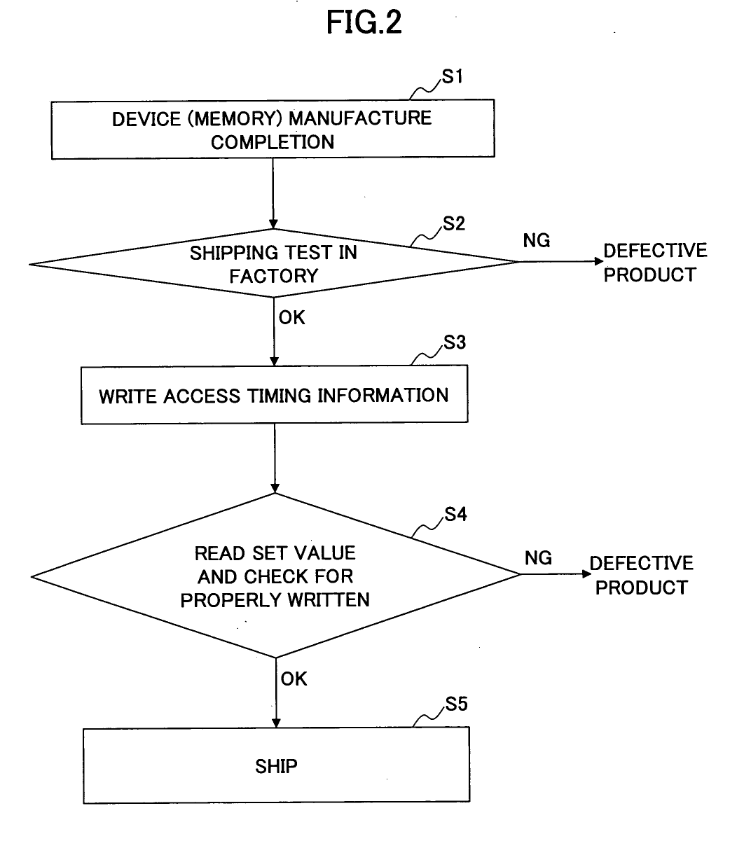

FIG. 2 shows a flow chart of a work for storing the access timing information 21 to the memory 20 before shipping the memory 20 as the slave side device.

When manufacture of the memory 20 is finished (Step S1), a shipping test is carried out (Step S2). After that, the access timing information 21 is stored (Step S3).

Next, in Step S4, it is determined whether or not the access timing information 21 have been properly written in the memory 20 as a product in Step S3. When it is finished successfully, the memory 20 is shipped.

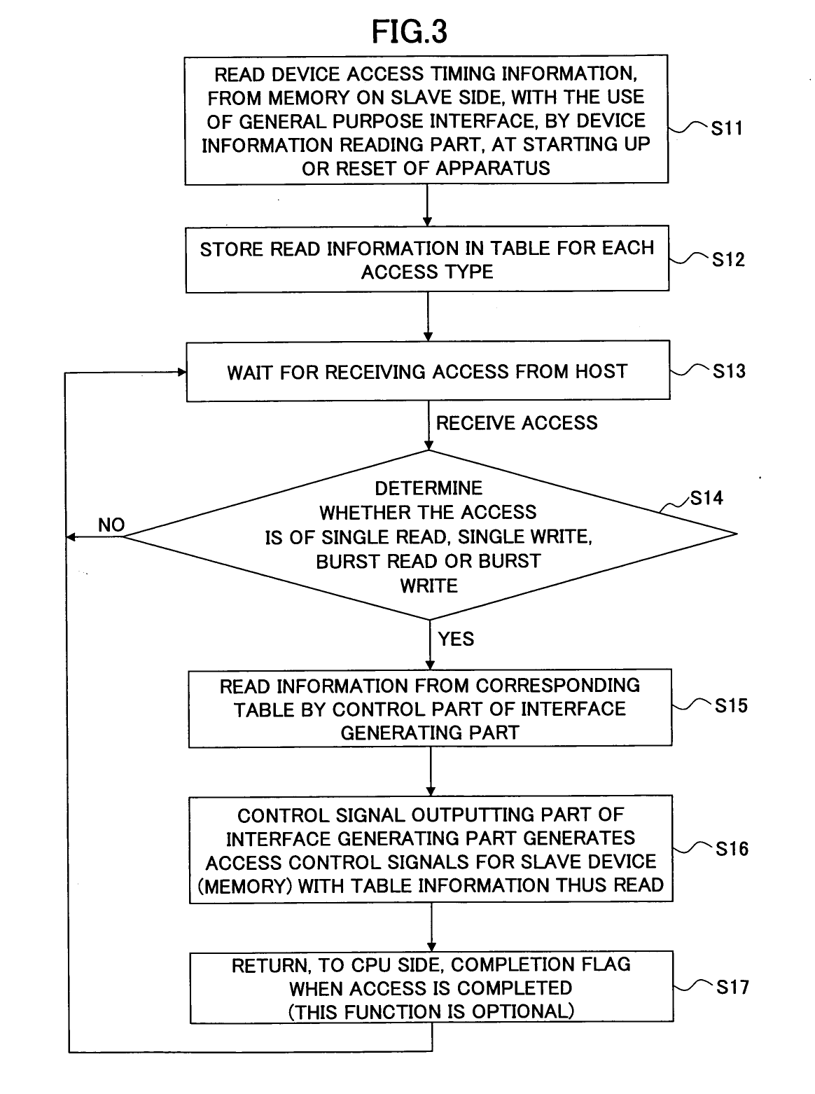

FIG. 3 shows a flow chart illustrating a flow of memory access operation in the information processing apparatus shown in FIG. 1.

When the information processing apparatus is started up, or reset operation is made on the information processing apparatus, the memory access apparatus 10 accesses, with the use of the general purpose interface, the memory 20 as the slave side device, from the device information reading part 13, and reads out the access timing information 21 stored in the memory 20 (Step S11).

The access timing information 21 thus read out with the device information reading part 13 is then stored as table data, together with access timing information for other devices (Step S12).

After that, the memory access apparatus 10 enters a state of waiting for access instructions which will be provided from the CPU 50 (Step S13).

When an access request is given by the CPU 50, the CMD identifying part 11 determines which type of access, the thus-given access request corresponds to (Step S14).

Next, in Step S15, a control part 12d (see FIG. 18) of the interface generating part 12 reads the access timing information 21 once stored in the device information reading part in Step S12. Further, in Step S16, the control part 12d generates access control signals suitable to the memory 20 as the slave side device based on the thus-read-out access timing information 21 (i.e., the table data, described later).

When predetermined read/write processing by means of the thus-generated access control signals is finished, the memory access apparatus 10 returns a predetermined completion flag signal to the CPU 50, returns to Step S13, and waits for a subsequent access request.

Next, details of a function of each functional part included in the memory access apparatus 10, shown in FIG. 1, will be described.

First, a function of the CMD identifying part 11 is described.

The CMD identifying part 11 has an interface function for the CPU 50, receives an access request from the CPU 50, and recognizes a request type, i.e., single write, burst write, single read or burst read (in Step S14 of FIG. 3).

Signals for communicating with the CPU 50 include, as shown in FIG. 1, CLK (i.e., a clock signal), ADR (i.e., an address signal), DATA (i.e., a data signal), XMCS (i.e., a chip select signal), R/XW (i.e., read/write signal), XRE (i.e., a read enable signal), XWE (i.e., a write enable signal), BURST (i.e., a continuous access flag signal) and ACK (i.e., the above-mentioned access completion flag signal).

Although a little difference may exist depending on each particular type of the CPU 50, basically the access request type is identified by a signal for reading/writing. A specific method of identifying is described below. It is noted that ‘burst’ means continuous data reading or writing.

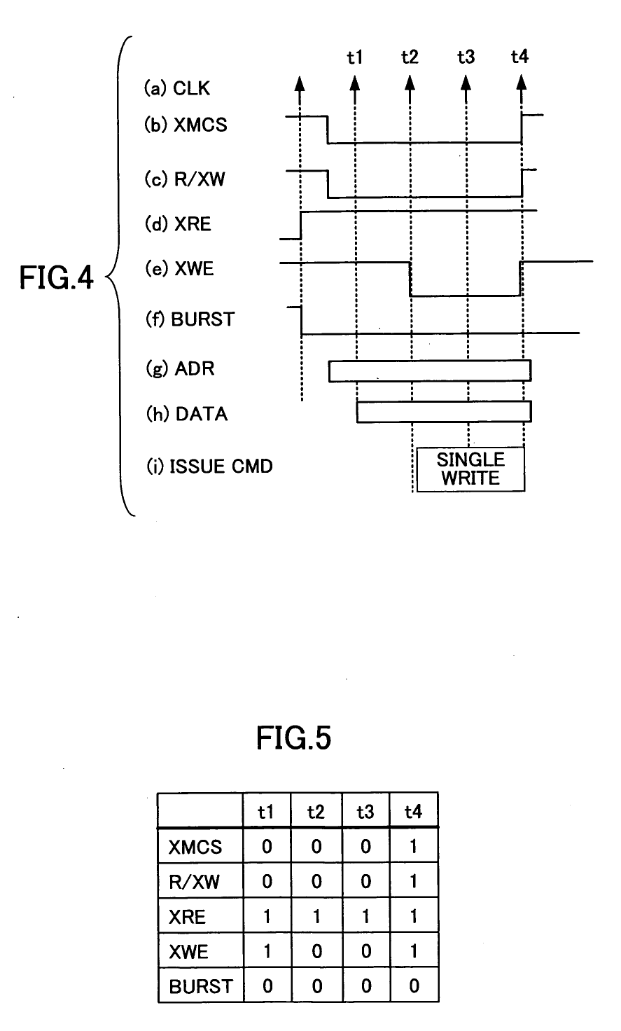

Change in the XMCS signal from the CPU 50 is detected (at clock timing t1 in FIG. 4 (b)), and, in synchronization with CLK based thereon, the respective signals are taken by sampling in time series (according to the clock timings, i.e., t1, . . . ). Identification between read and write is made by R/XW (FIG. 4 (c)), and identification between single and burst is made by BURST (FIG. 4 (f)).

That is, when R/XW is 0 in the timing t2 of FIGS. 4 and 5, determination is made as a write request, while, when the same is 1, determination is made as a read request.

When BURST is 0 at the timing t2, determination is made as a single access request, while, when the same is 1, determination is made as a burst access request.

Thus, at the timing t2, the type of the access request signals is recognized, and therewith, a corresponding command (i.e., CMD) is given to the interface generating part 12 in a subsequent stage (as shown in FIG. 4 (i)). In response to the command, the interface generating part 12 reads the corresponding access timing information as the table data, and according thereto, generates the access control signals suitable to the memory 20 and according to the access request type (Steps S15 and S16 of FIG. 3).

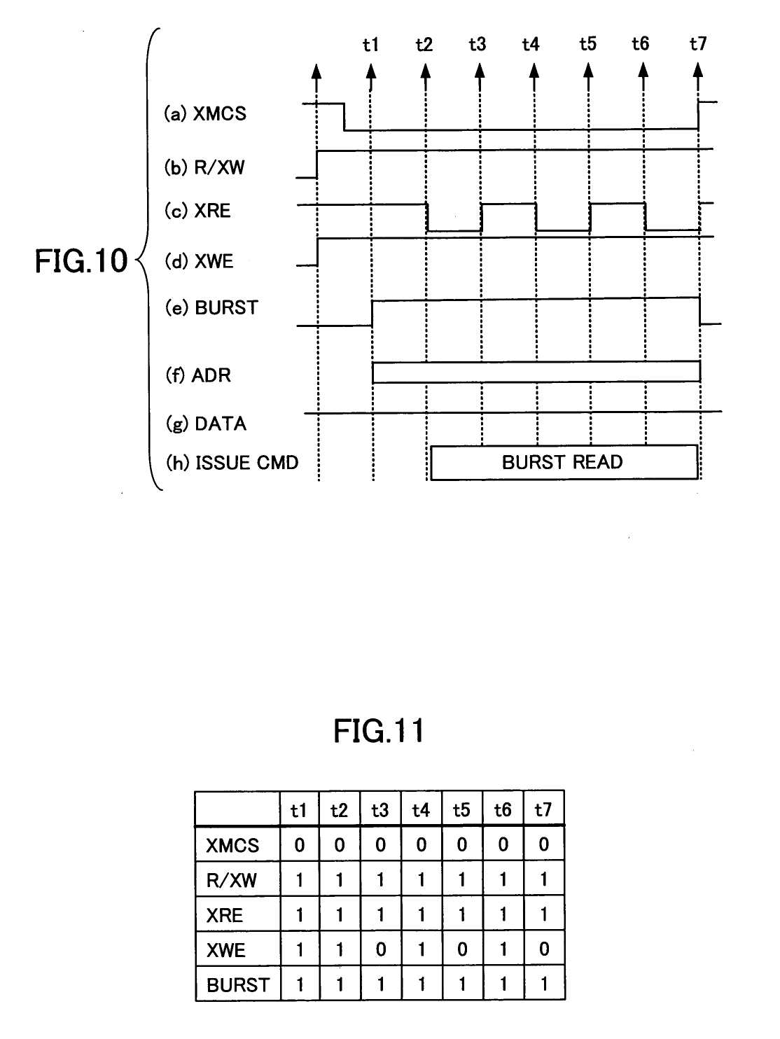

FIGS. 4, 5, 6, 7, 8, 9, 10 and 11 show timing charts of the access request signals for the respective request types, given by the CPU 50.

The CMD identifying part 11 holds the table data indicating the timing charts of the respective signals shown in FIGS. 5, 7, 9 and 11, and therewith, the CMD identifying part 11 can determine as to which request type, the given access request signals correspond to, when receiving the access request signals, corresponding to the timing charts of FIGS. 4, 6, 8 and 10, from the CPU 50, by comparing the given access request signals with the thus-held table data one by one.

In this case, for example, in the table data of FIGS. 5, 7, 9 and 11, the value of R/XW at the clock timing t2 is 0 when the request type is write (see FIGS. 5 and 7), while the same is 1 when the request type is read (see FIGS. 9 and 11) as mentioned above.

In the same way, in the table data of FIGS. 5, 7, 9 and 11, the value of BURST at the clock timing t2 is 0 when the request type is single (see FIGS. 5 and 9), while the same is 1 when the request type is burst (see FIGS. 7 and 11) as motioned above.

Accordingly, by comparing the levels of the received R/XW and BURST from the CPU 50, with the corresponding values of the table data, the request type of the access request signals can be determined.

A function of the device information reading part 13 is described next.

When power is supplied to the information processing apparatus of FIG. 1, first the access timing information 21 stored in the memory 20 as the slave side device, is obtained (Step S11 of FIG. 3).

Interface for thus obtaining the access timing information 21 from the memory 20 is the general purpose interface as mentioned above. That is, previously, an arrangement is made with the manufacturer of the memory 20 such that the interface for reading the access timing information 21, stored in the memory 20 before shipment, should be the general purpose interface.

It is noted that the access timing information 21 is definition information defining the type of the access control signals required when reading/writing data from/to the memory 20 itself.

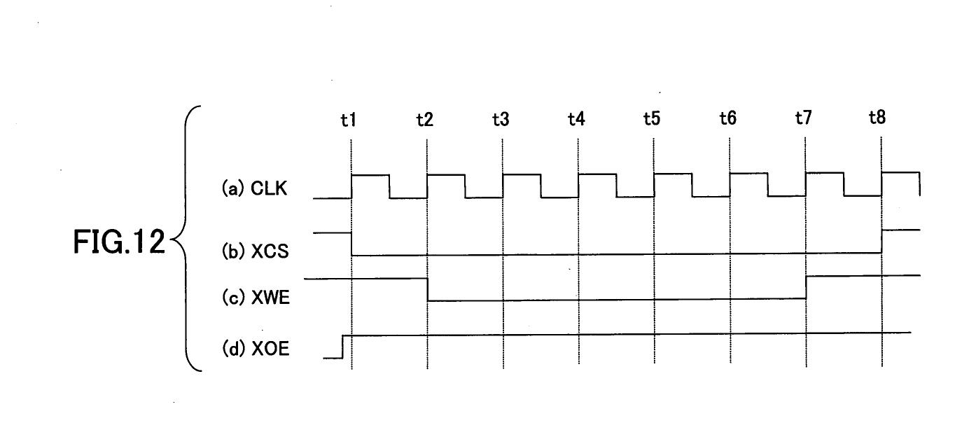

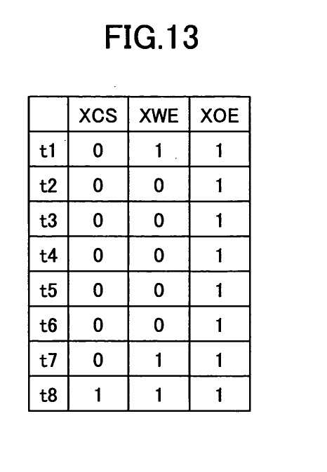

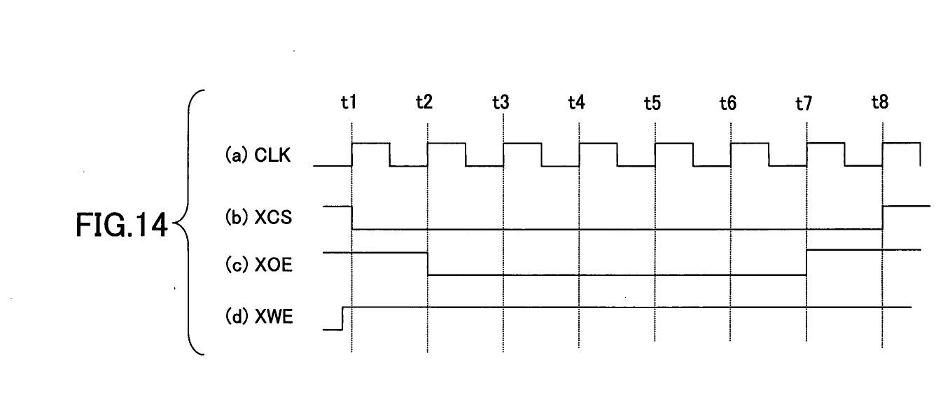

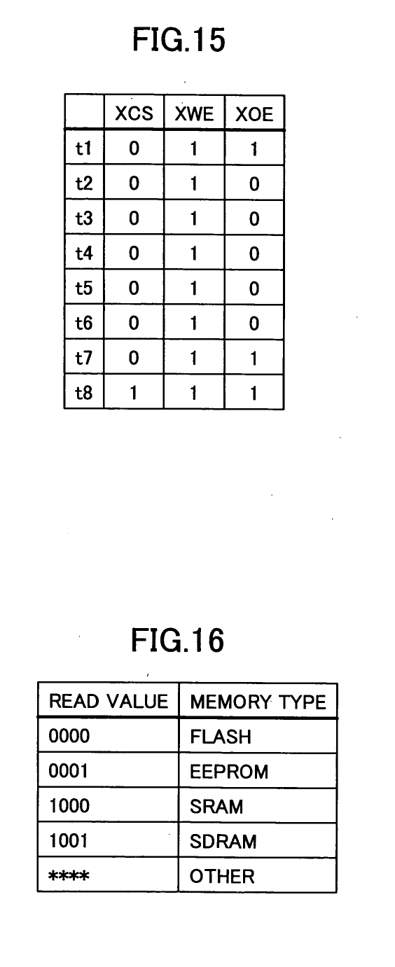

For example, for a case where, the type of the access control signals having access timing such as that shown in FIG. 12 or 14 are required when accessing the memory 20 as the slave side device, the access timing information 21 of table data such as that shown in FIG. 13 or 15 is stored, correspondingly.

It is noted that, the table data shown in FIG. 13 or 15 shows which level, i.e., H (i.e., high) or L (i.e., low), i.e., a value of 1 or 0, the respective signals XCS, XWE and XOE, i.e., the access control signals, have, at respective clock timings, i.e., t1, t2, t3, . . . , t8.

For example, according to FIG. 13, at clock timing t1, the respective signals, i.e., XCS, XWE, XOE, have values of 0, 1, 1, respectively. This corresponds to the fact that, according to FIG. 12, the corresponding signals, i.e., XCS, XWE, XOE, have levels L, H, H, respectively.

Other than it, the access timing signal 21 stored in the memory 20 includes information unique to the memory 20. For example, burst access (continuous access) information (i.e., table data shown in FIGS. 7 and 11, for example), refresh time information used when the memory 20 is a SDRAM, and so forth, are included.

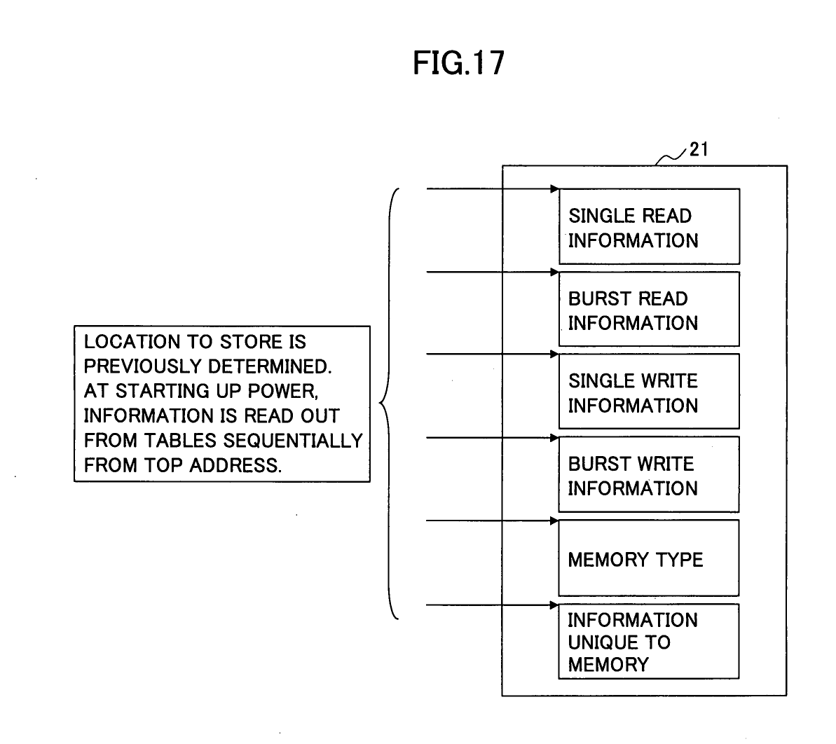

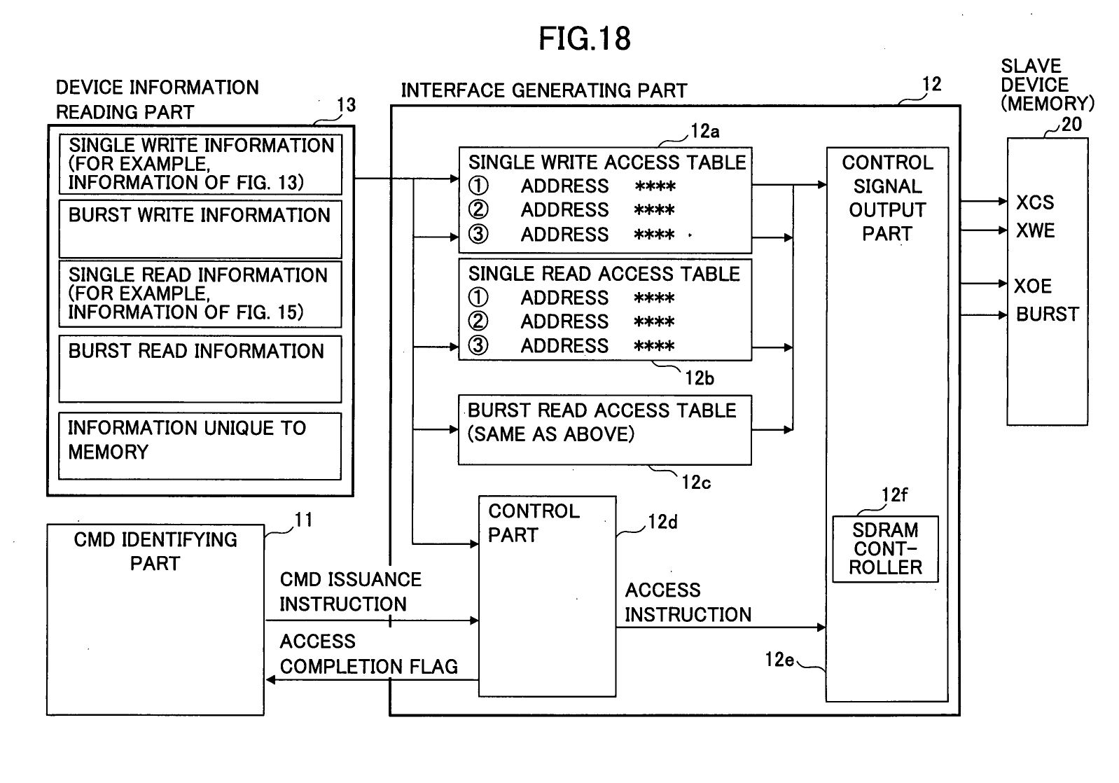

Next, an example of the contents of the access timing information 21 stored in the memory 20 as the slave side device, is described. It is noted that, as shown in FIG. 17, the access timing information 21 is stored in a predetermined area (in the table) of the memory 20, and the device information reading part 13 reads the access timing information 21 sequentially from top address of the area. As mentioned above, the interface used at this time is the general purpose interface, which may be either one of serial interface or parallel interface.

The above-mentioned example of the contents of the access timing information 21 stored in the memory 20 are:

1) access timing information for each of the access request types, i.e., single read, burst read, single write and burst write;

2) memory type information, i.e., information indicating which one the memory 20 is of, SRAM, SDRAM, flash memory, EEPROM or such; and

3) information unique to the memory 20, i.e., for example, refresh information for SDRAM if applicable, or such.

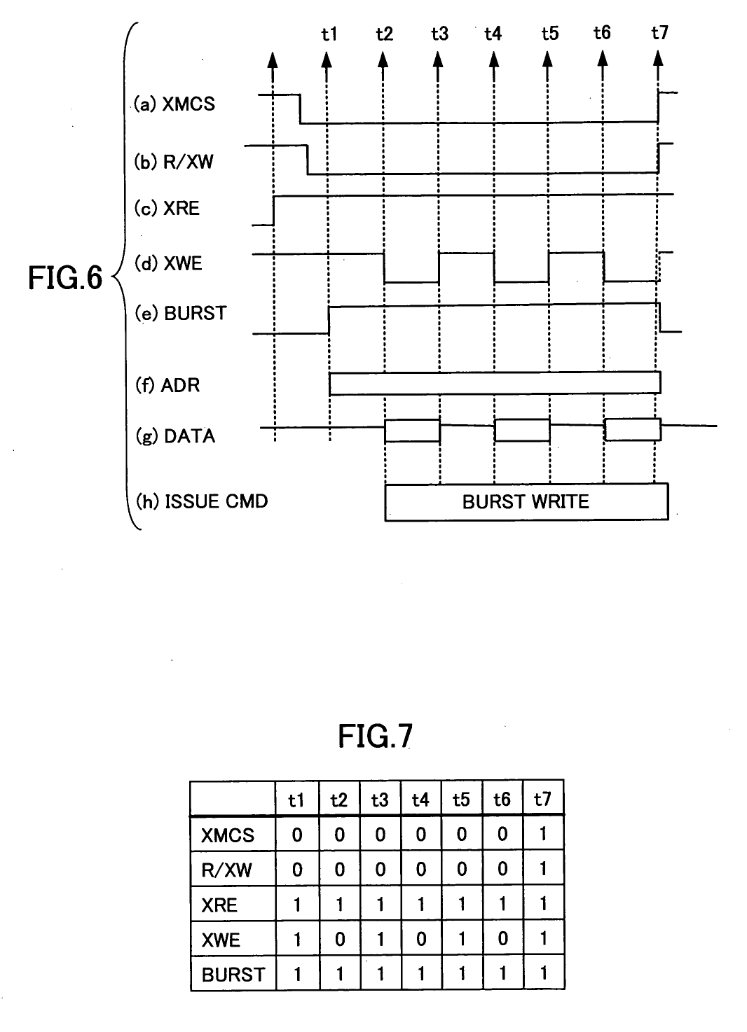

As to the memory type information of the above item 2), identification may be made as result of it being defined as shown in FIG. 6, for example.

When the memory 20 is an SDRAM, which is determined as a result of the memory type information being read included in the access timing information 21 of the memory 20, refresh operation is required as well known. For this purpose, the interface generating part 12 starts up a predetermined SDRAM controller 12f as will be described later (see FIG. 18).

Next, a function of the external interface 14 shown in FIG. 1 is described.

The external interface 14 provides interface for obtaining the access timing information 21 of the memory 20, externally with the use of a communication network, a USB memory or such.

Thus, the information processing apparatus in the embodiment of the present invention is configured to be applicable, not only to the above-described way of obtaining the access timing information 21 from the memory 20 as the slave side device itself, but also to another way that, in the memory 20, only information identifying the device itself is stored. In this other way, based on the identification information thus stored in the memory 20, the corresponding access timing information is obtained externally, thanks to the function of the external interface 14, through the communication network, the USB device, or such.

Next, a function of the interface generating part 12 is described.

FIG. 18 shows a detailed configuration of the interface generating part 12.

As shown, the interface generating part 12 includes tables 12a, 12b and 12c storing the access timing information (i.e., for example, the table data of FIGS. 13 and 15) obtained from the device information reading part 13. Further, the interface generating part 12 includes a control part 12d recognizing a command for each access request type sent from the CMD identifying part 11 and issuing predetermined reading instructions to read the corresponding table data, and a control signal output part 12e for generating the access control signals based on the thus-read-out table data to access the memory 20 as the slave side device.

The access timing information 21 stored as the table data 12a, 12b and 12c in the interface generating part 12 (previously read out from the memory 20 as mentioned above) includes the access timing information corresponding to the request types of the access request signals, i.e., read (single) and write (single), and, may further include, depending on the device (i.e., the memory 20), the access timing information corresponding to burst (continuous access) read and write, as shown in FIG. 18.

Furthermore, other than these, the area to store the information unique to the device (memory 20) is provided. The information unique to the device means information such as a refresh time for the case where the memory 20 is an SDRAM as mentioned above, for example. Based on this information, the SDRAM controller 12f is periodically started up, and thereby, refresh operation is carried out to the memory 20 if applicable.

That is, the SDRAM needs periodical charging of electric charge, and for this purpose, a timer is started up, and refresh operation is carried out on the memory 20 periodically. For this purpose, the SDRAM controller 12f starts up the timer, and carries out periodical refresh operation.

The areas in a predetermined storage device to store the table data 12a, 12b and 12c stored in the interface generating part 12 are previously determined.

As will be described later, the signal of access completion flag (ACK) of FIG. 18 is a signal for notifying the CPU side of a time at which data read/write is completed on the slave side, when the access span of the CPU 50 is shorter than the access span of the slave side device, i.e., the memory 20. The CPU 50 finishes the access operation when recognizing this access completion flag signal.

As signals for communication between the master and the slave, i.e., the memory access apparatus 10 and the memory 20, mainly the following signals are used commonly. However, types of the signals, the number of signals and specific access methods may differ depending on each particular type of the device.

1) basic clock signal (abbreviated as: CLK);

2) chip select signal (abbreviated as: XCS);

3) read enable signal (abbreviated as: XOE);

4) write enable signal (abbreviated as: XWE);

5) data bus signal (abbreviated as: DT);

6) address bus signal (abbreviated as: ADR); and

7) burst signal (abbreviated as: BURST).

For example, when a ‘single write’ request is received from the CPU 50, the CMD identifying part 11 recognizes it, and issues a write instruction to the control part 12d of the interface generating part 12. The control part 12d then transmits an instruction to the control signal outputting part 12e to cause it to read information from the single write access table 12a. The control signal outputting part 12e then reads the data, i.e., the access timing information to generate the access control signals for a ‘single write’ access, suitable to the type of the memory 20, from the table 12a. From the thus-read-out information, the access control signals suitable to the memory 20 as the slave side device are generated and output for the single write access thereto.

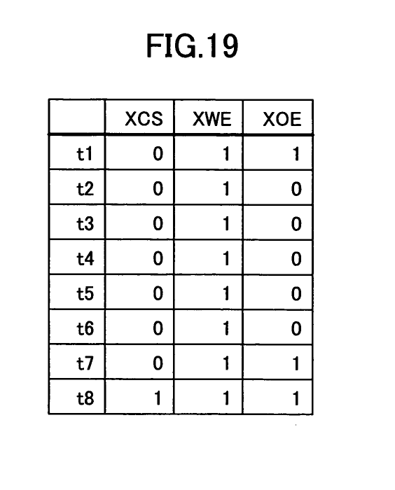

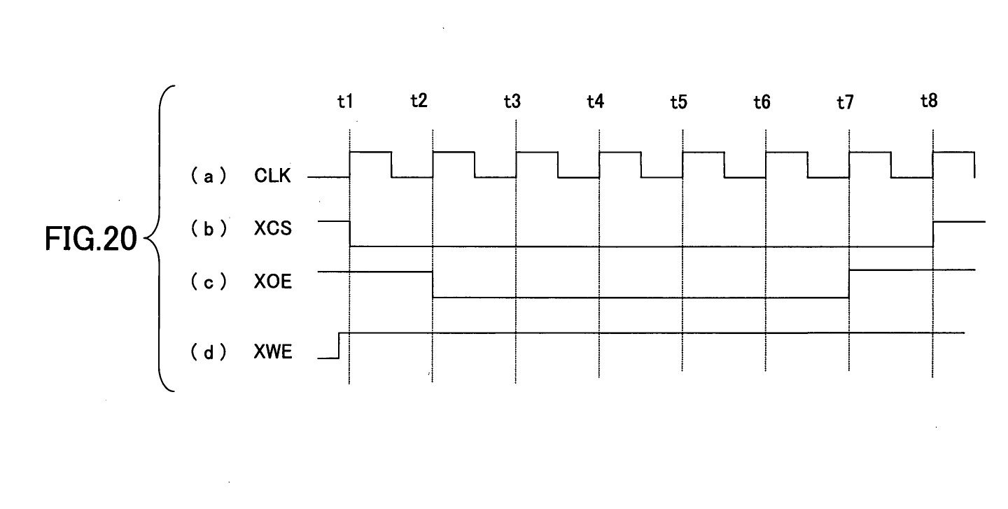

For example, it is assumed that the information read out from the table 12a is one shown in FIG. 19. In this case, according to the table data, the levels of the respective access control signals are generated according to elapse of time, i.e., t1, t2, . . . , t8 of clock timing. As a result, the access control signals XCS, XOE and XWE, as shown in FIGS. 20 (b), (c) and (d), occur, accordingly.

It is noted that, in this case, as to an address and information concerning a data bus used when actually accessing the memory 20, those input from the CPU 50 are used as they are. Or, after their clock timings are appropriately adjusted, these are output to the slave side device, i.e., the memory 20, together with the access control signal XCS, XWE and XOE generated as mentioned above by the interface generating part 12.

Next, a procedure of the method in the embodiment of the present invention will be described further specifically for a case, as an example, where the memory 20 as the slave side device is a flash memory.

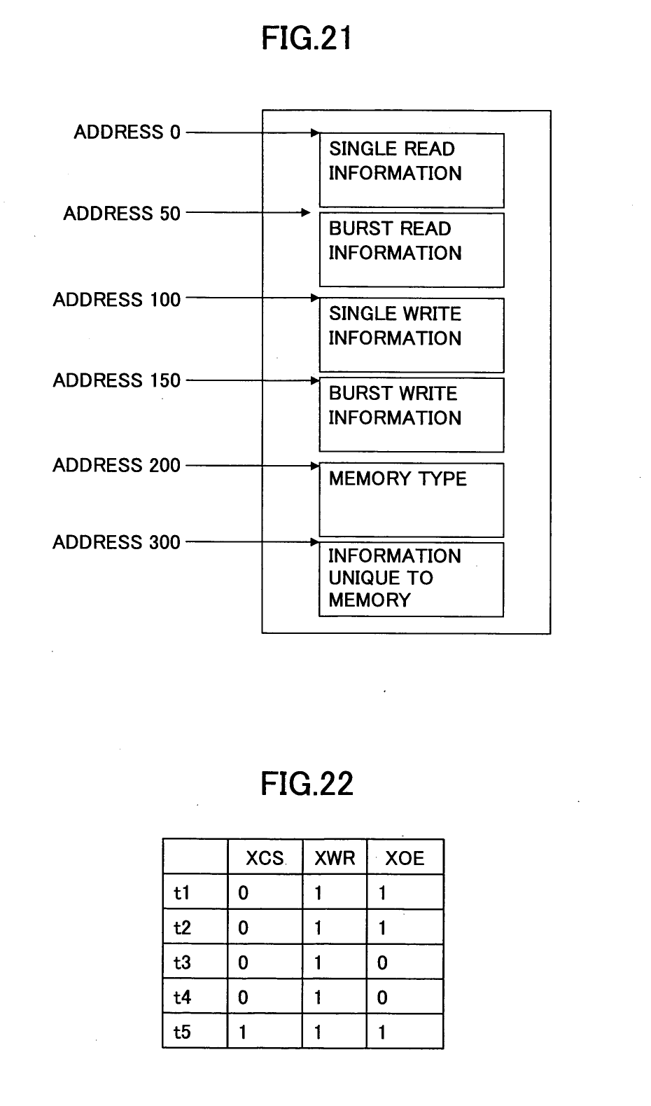

As mentioned above, a manufacturer of the memory 20 embeds the access timing information 21 in the memory 20 before shipping the same. At this time, the table data embedded in the memory 20 has the contents of FIG. 21, for example. It is preferable that, an arrangement is made such that, the top address of the respective areas of the memory 20 storing the respective sets of access timing information corresponding to the respective access types are previously determined in common among the memory manufacturers. For example, the table data of the access timing information is written in the memory 20 (i.e., the slave side device) before the shipment in such a manner that, the access timing information for single read is stored from the address 0, the access timing information for burst read is stored from the address 50, . . . , as shown in FIG. 21.

It is noted that, as the area storing the access timing information 21 in the memory 20 before the shipment, an area separate from an ordinary user area is provided in the memory 20. A configuration is provided in the memory 20 such that, this separate area is made non-volatile, information stored there is thus held even after the power supply to the memory 20 is broken, and also such a protection is made that the stored information cannot be rewritten externally. However, it is also possible to provide a configuration such that, the stored information can be rewritten only in a predetermined condition, i.e., only when a cipher command or such is input by an authorized staff of the manufacturer.

Next, a specific procedure for when, the memory 20 (flash memory) in which the access timing information 21 is previously written as mentioned above, is connected to the memory access apparatus 10, and the CPU 50 issues access request signals for reading/writing data from/to the memory 20, will be described.

As one example, it is assumed that a single read access is made to the memory 20.

A user first connects the memory 20 to the memory access apparatus 10.

Next, the power supply is started to the information processing apparatus of FIG. 1 including the memory access apparatus 10. As a result, the device information reading part 13 reads and obtains the access timing information 21 from the memory 20 as the slave side device.

The access timing information 21 thus read is then stored in the respective tables 12a, 12b and 12c of the interface generating part 12 (see FIG. 18). For the case of the above-mentioned single read access, the access timing information shown in FIG. 22 is applied.

Based on the access timing information, the interface generating part 12 generates, in synchronization with the clock signal CLK, output levels of the access control signals XCS, XWE and XOE according to the corresponding values thereof for each clock timing, i.e., t1, t2, . . . , t5 of FIG. 22, sequentially.

For example, for the clock timing t1, in FIG. 22, the respective values of XCS, XWE and XOE are 0, 1, 1 occur. Accordingly, the levels of the respective access control signals are generated to have the corresponding levels, i.e., L, H, H, and are output to the memory 20.

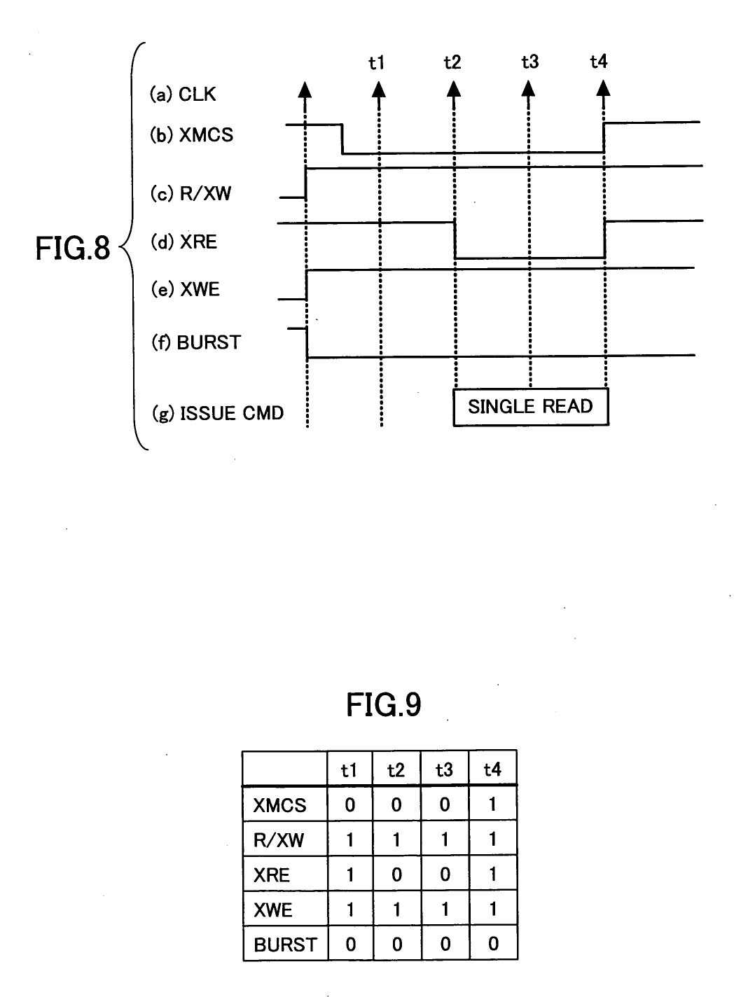

Actually, when the access request signals (for example, those shown in FIG. 8) are input from the CPU 50 to the memory access apparatus 10, the CMD identifying part 11 receives them. And, as described above, the levels of the thus-received access request signals are compared with the table data for the respective access types (i.e., those of FIGS. 5, 7, 9 and 11), one by one, and thus, it is determined that, the access request signals correspond to a single read access. As a result, the corresponding command is transmitted to the interface generating part 12 from the CMD identifying part 11.

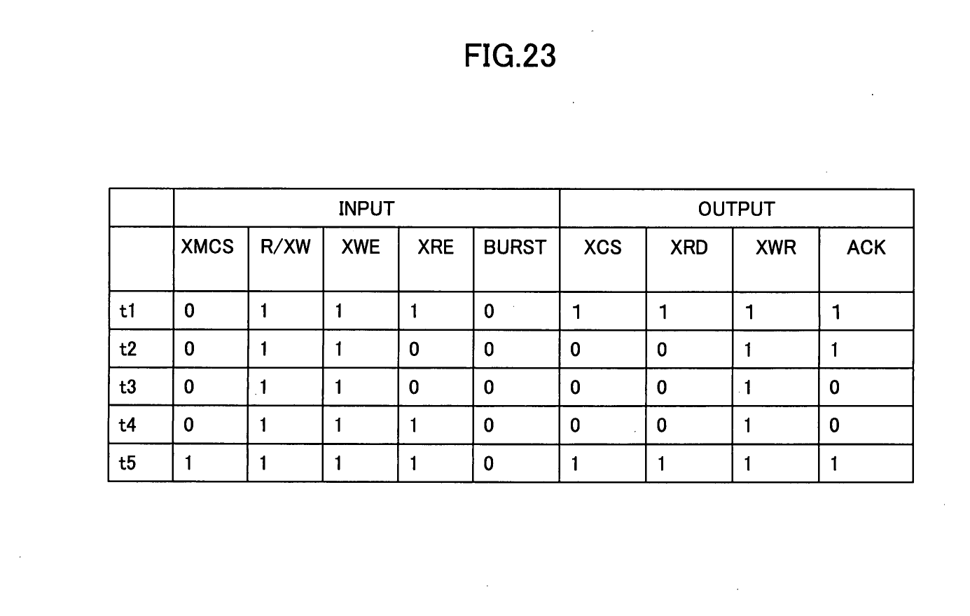

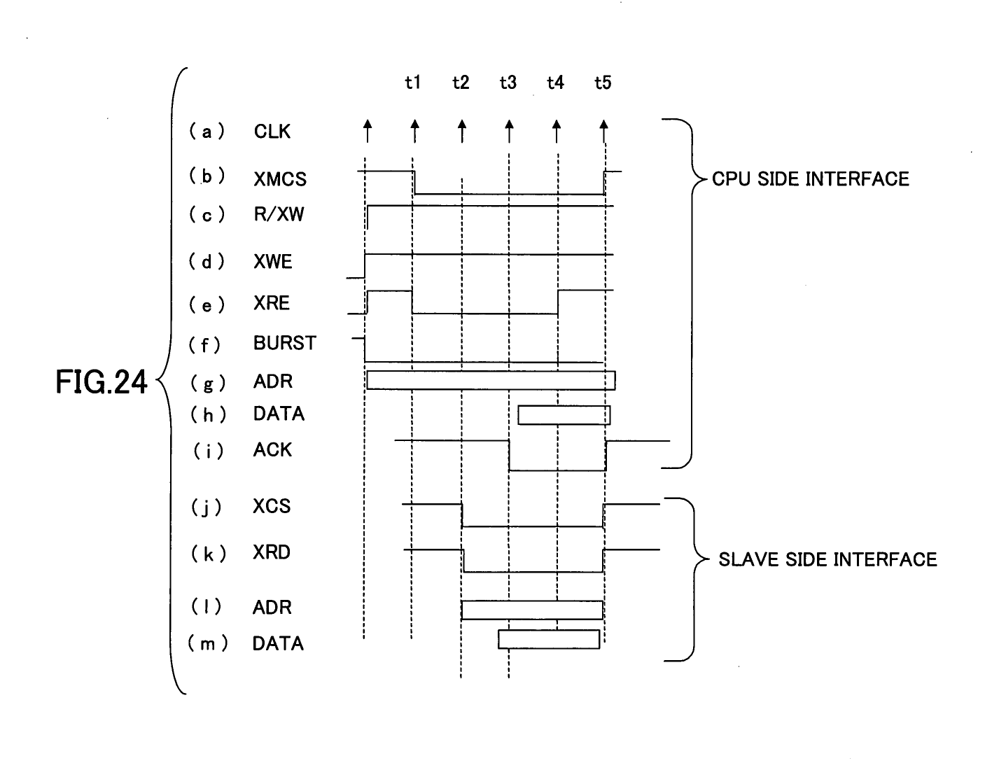

That is, at the clock timing t1, the CMD identifying part 11 receives, the input part of FIG. 23 and XMCS=0 (i.e., L) shown in FIG. 24 (b) from the CPU 50, and thus, the CMD identifying part recognizes that it receives an access request.

Then, at the clock timing t2, the CMD identifying part 11 receives, from the CPU 50, R/XW=1 and BURST=0 (FIGS. 24 (c) and (f)). Then, as described above, it determines that the access request requests a ‘single read’ access. That is, as shown in FIGS. 5, 7, 9 and 11, it is seen that, only FIG. 9 (for a single read access) has the corresponding values, i.e., R/XW=1 and BURST=0 at clock timing t2. As a result, the CMD identifying part 11 issues an instruction to the interface generating part 13 to cause it to read out the access timing information for the single read access.

In response thereto, the interface generating part 13 reads out the access timing information for single read access from the corresponding table data 12b, generates the access control signals based thereon, and outputs the same, i.e., XCS=0, XWR=1 and XRD=0 at the clock timing t2 (see FIG. 22, clock timing t2, or FIG. 23, the line of clock timing t2 of the output part, and FIGS. 24 (j) and (k) at clock timing t2).

Similarly, XRE=0 is received from the CPU 50 at clock timing t3 as shown in the input part of FIG. 23 and FIG. 24 (e), and as a result, it is recognized that the CPU 50 is in a state of waiting for reading data. The access control signals according to the table data for clock timing t3 (i.e., for clock timing t3 in FIG. 22, the output part of FIG. 23 and FIGS. 24 (j), (k), (l) and (m)) are then output to the memory 20.

In clock timing t4, the CMD identifying part 11 issues a read command to the interface generating part 12 according to the corresponding command from the CPU 50 (see clock timing t4 of FIG. 8).

Next, at clock timings t5, the interface generating part 12 outputs XCS=1 and ACK=1 to the memory 20 (see FIG. 22, the output part of FIG. 23 and FIG. 24 (j)) in response to XRE=1 at timing t4 and XMCS=1 at timing t5 (see FIG. 23, the input part and FIGS. 24 (b) and (e)). This means that a sequence of access operation to the memory 20 is completed.

Thus, as shown in FIGS. 23 and 24, the access request signals from the CPU 50 (i.e., the input part of FIG. 23 and FIG. 24 (a) through (f)) are appropriately converted into the access control signals (i.e., the output part of FIG. 23 and FIGS. 24 (j) and (k)) suitable to the particular type of the device (i.e., the flash memory) of the memory 20.

Further, in response to the access completion signal sent from the CPU 50 (see the output part of FIG. 23 and FIG. 24 (i)), the interface generating part 12 returns the access completion flag signal ACK to the CMD identifying part 11. The CMD identifying part 11 then returns the access completion flag signal ACK as it is to the CPU 50.

After recognizing this signal ACK, if the CPU 50 detects that data to read is valid, it takes the data and then, negates respective control signals.

It is noted that the signal ACK is used for the purpose that the CPU 50 achieves proper memory device access. That is, originally the access by the CPU 50 is completed in the clock timing t1 through t3. However, the access period is adjusted to be extended to the clock timing t4 since the slave side device (memory 20) needs the clock timing t2 through t4.

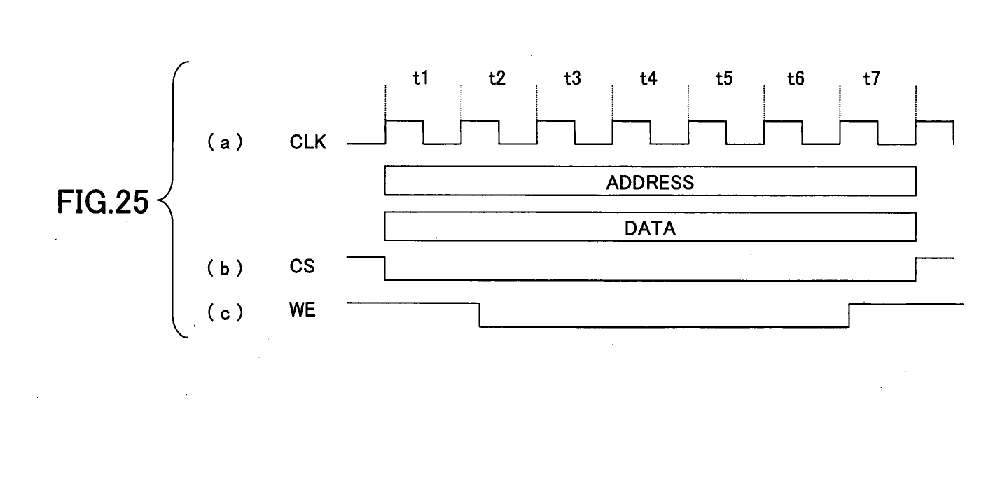

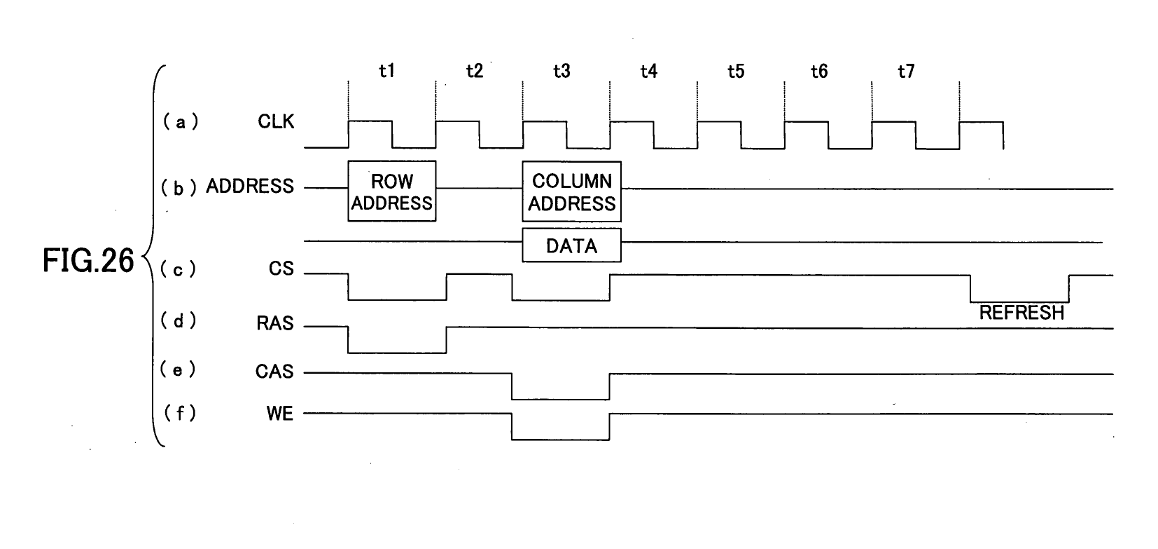

FIGS. 25 and 26 show an example of time charts concerning memory access operation of the memory access apparatus 10 for a case where the memory 20 is an SDRAM.

FIG. 25 shows an example of a time chart of access request signals from the CPU 50 to the memory access apparatus 10, and FIG. 26 shows an example of a time chart of access control signals from the memory access apparatus 10 to the memory 20.

The same as the operation example of memory access operation for the flash memory described above with reference to FIGS. 21 through 24, first an access request from the CPU 50 is received, then the interface generating part 12 converts the access request signals into the access control signals suitable to the SDRAM as the slave side device based on the corresponding table data. Then, the thus-obtained access control signals are output to the memory 20 (SDRAM), and thus, read/write operation from/to the memory 20 is properly achieved.

As mentioned above, periodical refresh is needed for the SDRAM, and thus, as the table for information unique to the memory (see FIG. 17), information required for refresh of the SDRAM, i.e., the memory 20 as the slave side device, is stored in the memory 20 as a part of the access timing information 21. This information is read out from the memory 20, and is then stored in the interface generating part 12 as the table data. This is then read out by the device information reading part 13, and thus, the timer of the SDRAM controller 12f is periodically started up as mentioned above, and a predetermined refresh signal is output to the memory 20 (see FIG. 26 (c)).

It is noted that, in FIGS. 25 and 26, the following signals are used: a clock signal (CLK); a chip select signal (CS); a write enable signal (WE); a row address strobe signal (RAS); and a column address strobe signal (CAS).

As a result of the conversion from the access request signals shown in FIG. 25 into the access control signals shown in FIG. 26 according to the corresponding table data of the access timing information 12 as mentioned above, the following operation is carried out.

That is, on the access request side, as shown in FIG. 25, an address signal and a data signal are provided during the clock timing t1-t7, CS is asserted during t1-t7, and WE is asserted during t2-t6.

In response thereto, through the above-mentioned signal conversion according to the table data of the access timing information 12 for the SDRAM of the memory 20, on the access control side, the corresponding row address signal is provided in t1, the corresponding column address signal is provided in t3, the data signal is provided in t3, CS is asserted in t1, t2 and t8, RAS is asserted in t1, CAS is asserted in t3 and WE is asserted in t3.

Thereby, the data of the data signal is written in the memory element at the clock timing t3, designated by the row address and column address given at the clock timings of t1 and t3, respectively.

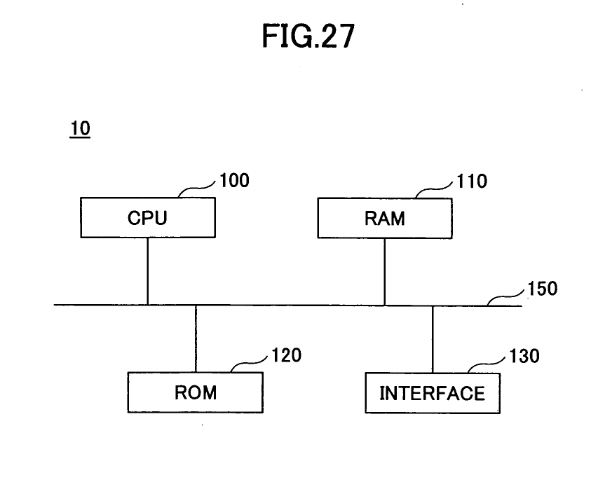

FIG. 27 shows a hardware configuration example of the memory access apparatus 10 of FIG. 18.

As shown, the hardware of the memory access apparatus 10 in this example includes a CPU 100, a RAM 110, a ROM 120, an interface 130 and a bus 150 connecting thereamong.

In this example, the above-mentioned respective functional parts, i.e., the CMD identifying part 11, the interface generating part 12, the device information reading part 13 and the external interface 14, are realized as a result of the CPU 100 operating according to respective instructions included in a control program stored in the ROM 120, and, the RAM 120 and the interface 130 being used thereby appropriately.

Thus, in the embodiment of the present invention, without particularly aware of access timing, a proper interface function is achieved between the master and the slave.

That is, in the related art, it was necessary to program an access condition corresponding to a memory to access, on a CPU side which accesses the memory. According to the embodiment of the present invention, the memory access apparatus 10 is inserted between the CPU 50 and the memory 20 to access, and, the memory access apparatus 10 obtains the access condition of the memory 20 from the memory itself, and generates the access control signals having the access timing suitable to the particular product of the memory 20. As a result, even when the memory 20 is replaced, the CPU 50 should not change the contents of the access request signals to apply for the memory access apparatus 10, since the memory access apparatus 10 appropriately converts the access request signals from the CPU 50 into the access control signals suitable to the memory 20 based on the access timing information of the memory 20 obtained from the memory 20 itself as mentioned above. As a result, the CPU 50 is free from programming the access condition again even when the memory to access is replaced. Thus, a development time can be effectively reduced, and the costs for the development can be saved accordingly.

As a result, the user should not be aware of interface timing of a device to access, and merely should make a physical connection to the device. As a result, possible human error such as design error can be effectively reduced, the quality of the product improves, and also, the apparatus development work can be simplified. As a result, the development procedure can be effectively shortened.

Further, by the embodiment of the present invention, it is possible to simplify a work of proving of interface between devices. That is, since the access timing information is stored in each device itself, this information may be utilized for a simulation carried out during the apparatus design procedure, and thus, possibility of human error at this time can be effectively reduced.

Thus, in the embodiment of the present invention, it is possible to omit a design work otherwise required when a replacement of a memory device occurs. As a result, a memory replacement can be easily achieved within a reduced time period, and thus, a design change, required by a finish of manufacture of a device or, required for the purpose of cost down, can be easily achieved, even when it requires a device replacement.

The above-described embodiments are those directed to an apparatus or a method for an access to a memory, as an example. However an embodiment of the present invention is not limited thereto. The present invention may be applied also to an apparatus or a method for an access to any other device.

The present invention is not limited to the above-described embodiments, and variations and modifications may be made without departing from the basic concept of the present invention claimed below.

The present application is based on Japanese Priority Application No. 2006-177267, filed on Jun. 27, 2006, the entire contents of which are hereby incorporated herein by reference.

What is claimed is:

1. A memory access apparatus for carrying out access to a memory for which a type of an access control signals required for accessing is different from each other, comprising:
an access control signal type information obtaining part configured to obtain, from the memory, information of the type of the access control signal for said memory to access.

2. The memory access apparatus as claimed in claim 1, wherein:
the type of the access control signal for the memory to access comprises a type of a signal waveform of the access control signal.

3. The memory access apparatus as claimed in claim 1, wherein:
said access control signal comprises a chip select signal, a read/write signal, a read enable signal, a write enable signal and a continuous access flag signal.

4. The memory access apparatus as claimed in claim 1, wherein:
said access comprises those of single write, burst write, single read and burst read.

5. The memory access apparatus as claimed in claim 4, comprising:
an access type identifying part configured to identify a type of access required by a command, by analyzing the command from a host; and
an access control signal generating part configured to generate the access control signal for the memory, according to the information of the type of the access control signal obtained by said access type identifying part, wherein:
said access control signal type information obtaining part reads, from said memory, the information of the type of the access control signal required for accessing the memory, according to the type of the access identified by said access type identifying part, from among the information previously stored for the respective ones of the types of the access, and provides the same to said access control signal generating part.

6. The memory access apparatus as claimed in claim 1, further comprising:
an external interface for obtaining the information of the types of the access control signals externally.

7. A memory access method for carrying out access to a memory for which a type of an access control signal required for accessing is different from each other, comprising:
an access control signal type information obtaining step of obtaining, from the memory, information of the type of the access control signal for said memory to access.

8. The memory access method as claimed in claim 7, wherein:
the type of the access control signal for the memory to access comprises a type of a signal waveform of the access control signal.

9. The memory access method as claimed in claim 7, wherein:
said access control signal comprises a chip select signal, a read/write signal, a read enable signal, a write enable signal and a continuous access flag signal.

10. The memory access method as claimed in claim 7, wherein:
said access comprises those of single write, burst write, single read and burst read.

11. The memory access method as claimed in claim 10, comprising:
an access type identifying step of identifying a type of access required by a command, by analyzing the command from a host; and
an access control signal generating step of generating the access control signal for the memory, according to the information of the type of the access control signal obtained in said access type identifying step, wherein:
said access control signal type information obtaining step reads, from said memory, the information of the type of the access control signal required for accessing the memory, according to the type of the access identified in said access type identifying step, from among the information previously stored for the respective ones of the types of the access, and provides the same to said access control signal generating step.

12. A memory manufacturing method comprising the step of:
embedding information of a type of an access control signal in a predetermined area of a memory for the purpose of enabling access to said memory, for which the type of the access control signal required for accessing is different from each other.

13. The memory manufacturing method as claimed in claim 12, wherein:
the type of the access control signal for the memory to access comprises a type of a signal waveform of the access control signal.

14. The memory manufacturing method as claimed in claim 12, wherein:
said access control signal comprises a chip select signal, a read/write signal, a read enable signal, a write enable signal and a continuous access flag signal.

15. The memory manufacturing method as claimed in claim 12, wherein:
said access comprises those of single write, burst write, single read and burst read.

16. The memory manufacturing method as claimed in claim 15, wherein:
in said step of embedding in the memory the information of the type of the access control signal, the information of the type of the access control signal required for accessing said memory, for each of those of the types of access, is embedded in the corresponding one of respective different areas of said memory.
